(19) United States
(12) Patent Application Publication
(10) Pub. No.: US 2012/0223832 A1
(43) Pub. Date: Sep. 6, 2012

(54) VEHICLE PRESENCE NOTIFICATION APPARATUS

(75) Inventor: Toshiaki NAKAYAMA, Miyoshi-city (JP)

(73) Assignee: DENSO CORPORATION, Kariya-city (JP)

(21) Appl. No.: 13/409,473

(22) Filed: Mar. 1, 2012

(30) Foreign Application Priority Data
Mar. 2, 2011 (JP) 2011-45130

(51) Int. Cl. B60Q 1/26

(52) U.S. Cl. 340/463

(57) ABSTRACT

A vehicle presence notification apparatus generates and radiates a pseudo-idling sound outward from a vehicle by way of a vehicular horn and a parametric speaker when the vehicle is in a temporary stop state. Further, the vehicle presence notification apparatus generates from two horizontally-adjacent piezoelectric vibrators, reverse phase supersonic sounds during the temporary stop state. The supersonic sounds generated from two horizontally-adjacent piezoelectric vibrators have the same phase in diagonally right and left directions, thereby acquiring an extended cover range.

### CROSS REFERENCE TO RELATED APPLICATION

The present application is based on and claims the benefit of priority of Japanese Patent Application No. 2011-45130, filed on Mar. 2, 2011, the disclosure of which is incorporated herein by reference.

### TECHNICAL FIELD

The present disclosure generally relates to a vehicle presence notification apparatus that generates a notification sound, such as an engine sound, to notify the surrounding area about the presence of the vehicle.

### BACKGROUND

Pedestrians around a street may recognize the presence of a vehicle by way of a sound, such as an engine sound, produced by the vehicle. For example, a pedestrian may recognize that the vehicle is in a stop condition, such as when the vehicle is stopped at a traffic light or a crosswalk, by way of the idling sound produced by the engine. Recognizing a vehicle by way of sound may be particularly important for pedestrians that are visually impaired and pedestrians that are occupied with other tasks and are not aware of their surroundings.

A vehicle may create little to no sound, and are referred to as quiet vehicles. Such vehicles may include electric vehicles, hybrid vehicles, and, even, conventional engine vehicles that include an idle-stop function. An electric vehicle may be powered by battery or fuel cell, and does not have an engine. Therefore, an electric vehicle may not generate an engine or idling sound. Further, a hybrid vehicle that includes an engine with an idle-stop function may not generate an engine or idle sound during a stop condition because the engine is turned off during the stop condition. Additionally, a vehicle that is equipped with an engine, but also has an idle-stop function, does not generate an engine sound during a stop condition of the vehicle. Also, due to recently developed technology aimed at reducing engine sound, it may also be difficult for a pedestrian to recognize a conventional vehicle, if the engine of the vehicle is very quiet.

Due to the lack of sound produced by such quiet vehicles, a pedestrian may not be aware of the presence of such vehicle, especially when the vehicle is in a stop condition and no idle sound is generated due to the lack of an engine or perhaps the engine is turned-off due to an idle-stop function. Therefore, pedestrians may be encountered with an unsafe situation when a vehicle is stopping at an intersection across which he/she is going to walk, and the pedestrian does not recognize the presence of the vehicle before crossing the street, which creates an unsafe environment for both the pedestrian and the driver.

A quiet vehicle may be equipped with a vehicle notification apparatus that outputs a sound to notify others in the vicinity of the presence of the vehicle. Such an apparatus is disclosed in Japanese Patent Laid-Open No. 2005-289175 (JP '175).

The problems associated with the above situation are explained with reference to FIGS. 9A, 9B, and 9C. In FIGS. 9A, 9B, and 9C a vehicle X and a vehicle Y, which may be referred to as vehicles X, Y, and a pedestrian P1 and a pedestrian P2, which may be referred to as pedestrians P1, P2, are shown. The vehicles X, Y may be a quiet vehicle, as described above, and produce little to no sound, especially when in a stop condition.

FIG. 9A depicts a crosswalk that is positioned on a straight road with the vehicles X, Y stopped at the crosswalk and the pedestrians P1, P2 positioned on either side of the crosswalk. FIG. 9B depicts a cross-walk positioned at a T-shape intersection of two roads with the pedestrians P1, P2 positioned on either side of the crosswalk. FIG. 9C depicts multiple crosswalks positioned at a cross-shape intersection with the pedestrian P1, P2 positioned on either side of a crosswalk.

In each of the situations depicted in FIGS. 9A, 9B, and 9C when the vehicles X, Y are in a stop condition in front of the crosswalk and do not generate an idling sound, the pedestrians P1, P2 may not recognize the presence of vehicles X, Y before or while crossing the street. In particular, pedestrians P1, P2 may not recognize the vehicles X, Y if the pedestrians P1, P2 are visually impaired or not paying attention.

In addition, with respect to FIGS. 9A, 9B, 9C, when the pedestrian P1 begins to cross the street, the distance between the pedestrian P1 and the vehicle X may be significant, such that the pedestrian P1 may not hear the sounds produced by the vehicle X. For example, if the vehicle X is equipped with a vehicle notification apparatus that produces a pseudo-idling sound, such a sound may not be heard by the pedestrian P1 because of the distance between the vehicle X and the pedestrian P1. Similarly, when the pedestrian P2 starts to cross the street, a distance between the pedestrian P2 and the vehicle Y may be significant, such that the pedestrian P2 may not hear the sounds produced by the vehicle Y.

Therefore, when the distance between the pedestrian and the vehicle is significant, such that a notification sound (e.g. an idling sound) from the vehicle is not heard by the pedestrian, the possibility of the pedestrian not recognizing the presence of the vehicle increases, thereby creating an unsafe environment for the pedestrian and the driver.

### SUMMARY

This section provides a general summary of the disclosures, and is not a comprehensive disclosure of its full scope or all of its features.

A vehicle presence notification apparatus includes a sound wave generation unit and a control circuit. The sound wave generate unit generates and radiates a sound outward from a vehicle. The control circuit controls the sound wave generation unit to generate a notification sound that notifies existence of the vehicle when the vehicle is in a temporary stop state. The vehicle presence notification apparatus may notify a pedestrian about the presence of the vehicle, especially when the vehicle is a quiet vehicle.

Further, the control circuit may further control the sound wave generation unit to generate the notification sound when the vehicle is in a temporary stop state and, additionally, when a predetermined driving condition is fulfilled. In such manner, the generation of the notification sound in a non-suitable situation or condition is prevented.

The sound wave generation unit may include a parametric speaker that has a supersonic speaker that radiates a supersonic sound outward from the vehicle. The supersonic speaker may have a plurality of supersonic transducers that emit the supersonic sound. The plurality of the supersonic transducers may be positioned in a horizontal array in a collective arrangement. The control circuit may control horizontally-adjacent supersonic transducers to generate reverse-phased supersonic sounds for generating the notification sound when the vehicle is in a temporary stop state. That is, at least two adjacently-arranged transducers may generate reverse phase supersonic sounds therefrom, thereby, in diagonal directions, allowing the two adjacent supersonic sounds to have the same phase and to intensify/amplify with each other to reach a distant location from the vehicle, when the supersonic sounds travels in such diagonal directions relative to the speaker.

The vehicle presence notification apparatus may further include a louver that reflects the supersonic sound emitted by a portion of the supersonic transducers to a rightward direction of the vehicle. By positively reflecting or concentrating the supersonic sound in the rightward direction of the vehicle, the coverage area of the notification sound may be increased.

### BRIEF DESCRIPTION OF THE DRAWINGS

FIG. 1A is an illustration of coverage of a pseudo-idling sound;

FIGS. 1B and 1C are illustrations of a phase relationship of supersonic sounds generated by two adjacent supersonic transducers, in a first embodiment of the present disclosure;

FIG. 2 is a block diagram of a vehicle presence notification apparatus in the first embodiment of the present disclosure;

FIG. 3 is an illustration of a supersonic speaker and a vehicular horn disposed in a vehicle in the first embodiment of the present disclosure;

FIG. 4A is a cross-sectional view of the vehicle presence notification apparatus in the first embodiment of the present disclosure;

FIG. 4B is a perspective view of the vehicle presence notification apparatus in the first embodiment of the present disclosure;

FIG. 5 is a diagram of a frequency characteristic of the sound generated by a vehicular horn of the vehicle presence notification apparatus in the first embodiment of the present disclosure;

FIGS. 6A, 6B, 6C, 6D and 6E are illustrations of an operation principle of a parametric speaker of the vehicle presence notification apparatus in the first embodiment of the present disclosure;

FIGS. 7A and 7B are illustrations of a louver of the vehicle presence notification apparatus in a second embodiment of the present disclosure;

FIGS. 8A and 8B are illustrations of a louver of the vehicle presence notification apparatus in a third embodiment of the present disclosure; and

FIGS. 9A, 9B, and 9C are illustrations of a crosswalk with vehicles and pedestrians.

### DETAILED DESCRIPTION

A vehicle presence notification apparatus of the present disclosure is explained with reference to the drawings. The following description is merely exemplary in nature and is in no way intended to limit the disclosure, its application, or uses. For purposes of clarity the same reference numbers will be used in the drawings to identify similar elements.

### First Embodiment

A vehicle is equipped with a vehicle presence notification apparatus. The vehicle is a quiet vehicle, such as an electric vehicle that is powered by a battery or fuel cell technology or a hybrid car that is powered by a motor and an engine with an idle stop function. The idle stop function is a function that stops the engine of the vehicle when the vehicle is at a stop (e.g., when a speed of the vehicle is equal to 0 km/h with a brake pedal of the vehicle being stepped down) and restarts the engine when the vehicle starts to travel again (e.g., when the brake pedal is released). In general, the vehicle is mainly a quiet vehicle that generates very little to no sound. The vehicle presence notification apparatus notifies pedestrians of the existence or presence of the vehicle by way of a notification sound.

The vehicle presence notification apparatus radiates a notification sound, which may be a pseudo-idling sound, from the vehicle when the vehicle is in a stop condition. The stop condition may be provided as when the vehicle is in a temporary stop state, such as in-front of a traffic light, a stop sign, a crosswalk, or the like.

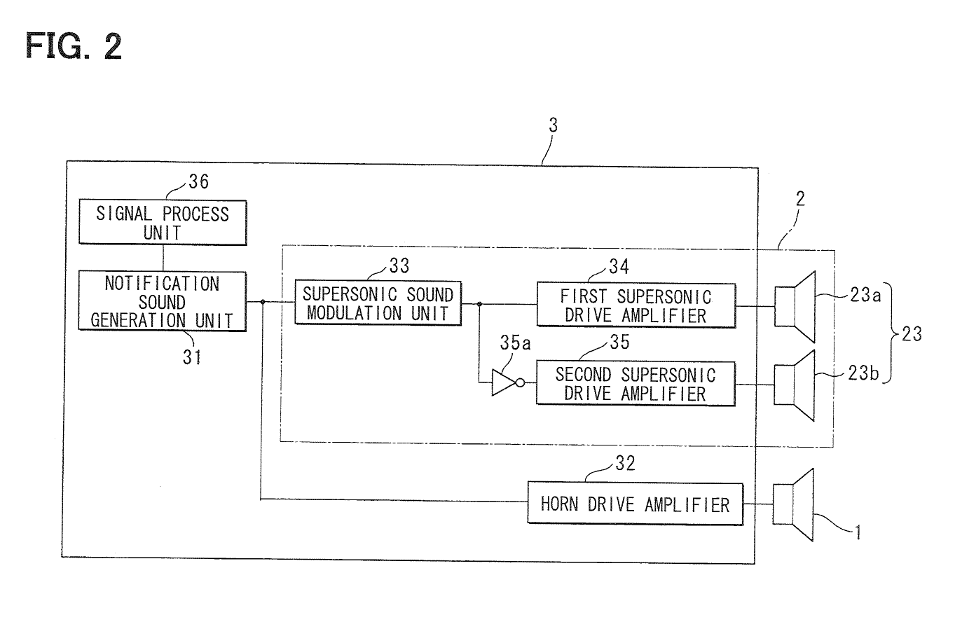

With reference to FIG. 2, the vehicle presence notification apparatus includes a vehicular horn 1 used as a dynamic speaker, a parametric speaker 2; and a control circuit 3 for controlling the operation of the vehicular horn 1 and the parametric speaker 2.

(Vehicular Horn 1)

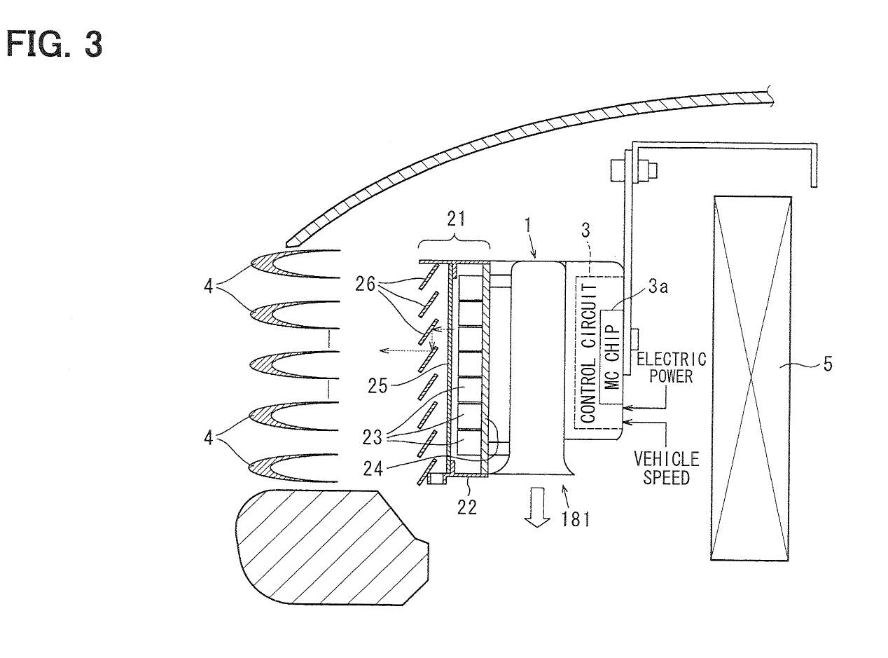

With reference to FIG. 3, the vehicular horn 1 is disposed between a front grille 4 and a heat exchanger 5. The vehicular horn 1 may be an electro-magnetic type horn that generates a warning sound when a horn switch (e.g., a horn button on a steering wheel) is operated by a user of the vehicle. The vehicular horn 1 generates the warning sound when a self-excitation voltage is above a threshold voltage, such as 8 V or more.

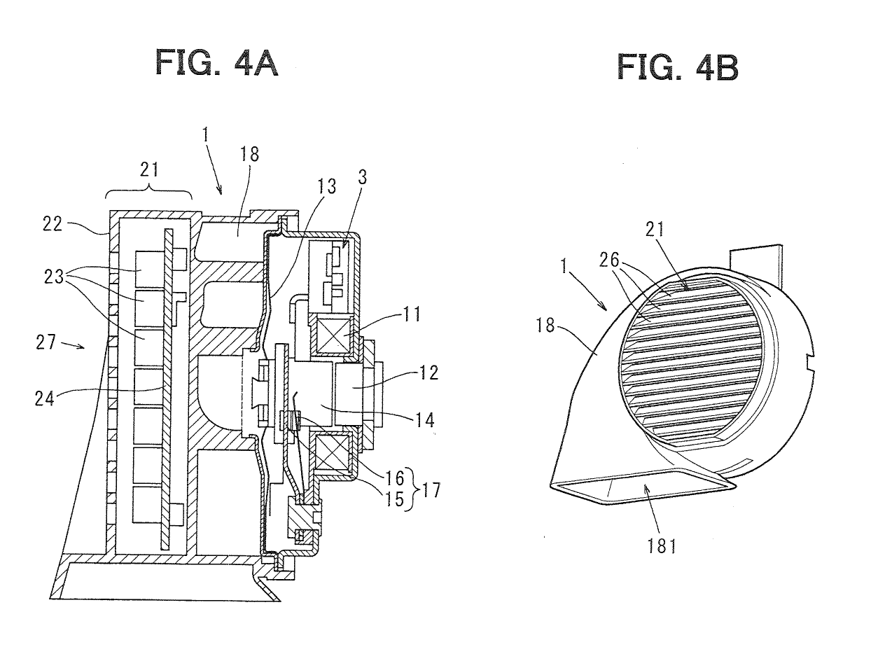

With reference to FIGS. 4A and 4B, the vehicular horn 1 includes a coil 11 to generate a magnetic force, a fixed iron core 12, a movable iron core 14, and a movable contact point 16. The fixed iron core 12 outputs an attraction force that is generated as a magnetic force from the coil 11, and may be referred to as a magnetic attraction core.

The movable iron core 14 is supported at the center of a vibration board 13 or a diaphragm. The attraction force provided by the fixed iron core 12 moves the movable iron core 14 towards the fixed iron core 12, and, as a result, the movable contact point 16 decouples from a fixed contact point 15, which interrupts the flow of electric current supplied to the coil 11.

In particular, the self-excitation voltage is supplied across the coil 11 via power terminals that are coupled to the ends of the coil 11, and a current flows across the coil 11. When the self-excitation voltage is above a threshold (i.e., the voltage is equal to or greater than 8 V), an attracting action and a returning action is repeatedly performed within the vehicular horn 1.

Specifically, in regards to the attracting action, when the current flows through the coil 11, an electromagnetic field is generated and an attraction occurs between the movable iron core 14 and the fixed iron core 12, such that the movable iron core 14 moves towards the fixed iron core 12. Due to the movement of the movable iron core 14 towards the fixed iron core 12, the moveable contact point 16 decouples from the fixed contact point 15, causing the current to stop flowing through the coil 11.

Once, the current has stopped flowing through the coil 11, the electromagnetic field is no longer generated and the moveable iron core 14 returns to its initial position, which is the start of the returning action. Due to the biasing of the movable iron core 14, the movable contact point 16 couples with the fixed contact point 15, and the current resumes flowing through the coil 11, thus restarting the attracting action.

In other words, an electric current interrupter 17, which allows and prevents the current from flowing through the coil 11, is formed by the fixed contact point 15 and the movable contact point 16.

Due to the attracting and returning action, which prevents and allows the current to flow through the coil 11, the moveable iron core 14 causes a vibration of the vibration board 13, and the vehicular horn 1 generates the warning sound.

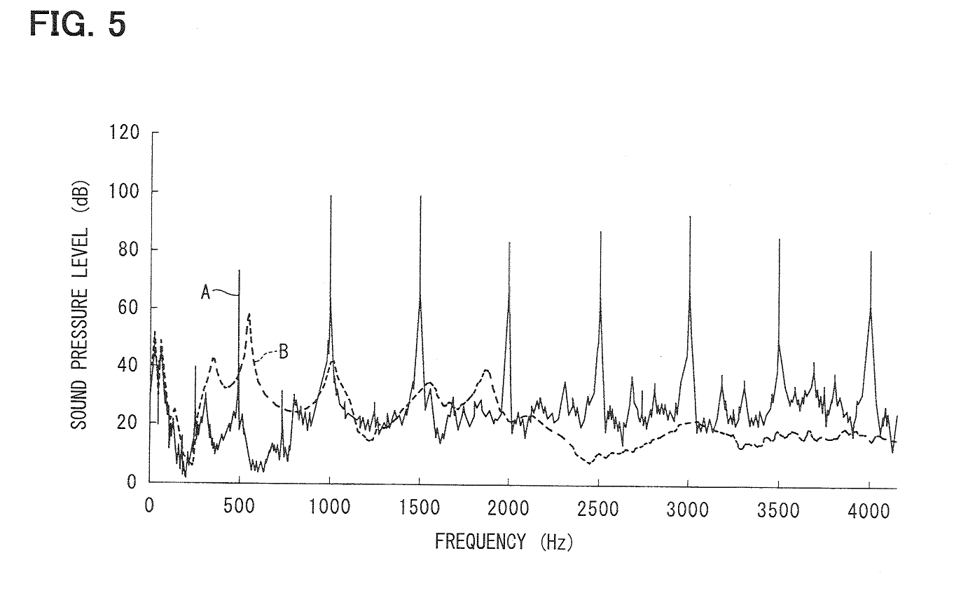

More practically, the frequency characteristics of the warning sound from the vehicular horn 1 when the self-excitation voltage is provided to the vehicular horn 1 is shown by a solid line A in FIG. 5.

Further, in the present embodiment, the vehicular horn 1 is used as a dynamic speaker when a driving signal of a separate excitation voltage that is lower than the self-excitation voltage (i.e., a voltage lower than 8 V) is provided to the vehicular horn 1.

The frequency characteristics of the vehicular horn 1 at a time of using the vehicular horn 1 as a dynamic speaker is shown by a dashed line B in FIG. 5. The dashed line B shows the frequency characteristics when a sweep signal (i.e., a variable signal transiting from a low frequency to a high frequency) of 1 V in a sine wave form is provided for the vehicular horn 1.

The vehicular horn 1 in the present embodiment includes a swirl shape horn 18 (i.e., a trumpet member in a swirling shape, or a sound tube in a swirl shape), as shown in FIG. 4B.

The vehicular horn 1 is arranged to radiate the pseudo-idling sound substantially evenly around the vehicle. As a practical example, the swirl shape horn 18 of the vehicular horn 1 has a horn opening 181, from which the sound is radiated, and is directed in a downward direction of the vehicle to face the road surface. The direction of the horn opening 181 may also be set to another direction, and such directivity may be realized by using a reflector or the like.

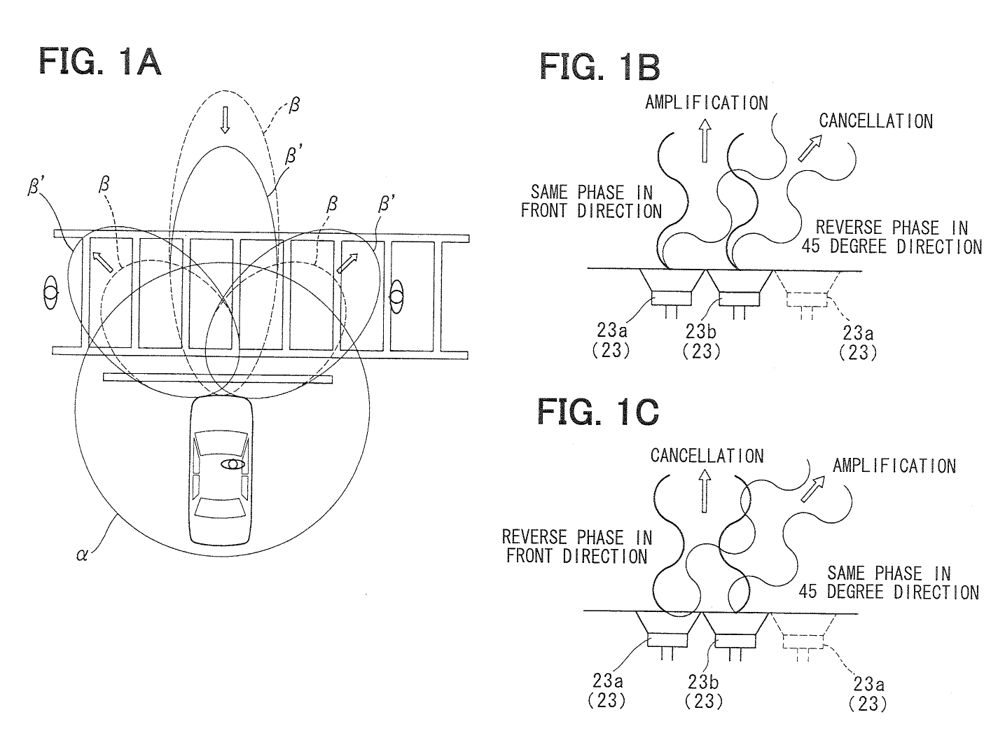

In FIG. 1A, a solid line a shows a coverage area of the pseudo-idling sound from the vehicular horn 1, which is determined as an area with its sound pressure value measured as 50 dB or more.

(Parametric Speaker 2)

The parametric speaker 2 is implemented as a supersonic speaker 21 that generates a supersonic sound.

The supersonic speaker 21 is a supersonic vibration device that vibrates air at a frequency of 20 kHz or greater, which is not audible to the human ear. The supersonic speaker 21 is disposed in the vehicle to radiate the supersonic sound in a frontward direction of the vehicle.

More practically, the supersonic speaker 21 is disposed in the swirl shape horn 18 of the vehicular horn 1, and the swirl shape horn 18 is disposed in the vehicle with its swirling plane arranged to be a front facing side of the horn 18. In such manner, the supersonic speaker 21 radiates the supersonic sound outward in a front direction of the vehicle.

The supersonic speaker 21 of the present embodiment includes a supersonic speaker housing 22, which, for example, is made by resin and is either attached or integrated with the swirl shape horn 18, and also includes a plurality of supersonic transducers 23 in the supersonic speaker housing 22.

The structure of the supersonic transducer 23 in the present embodiment is well-known, and has piezoelectric elements that expand and contract according to the applied voltage (i.e., the voltage from charge and discharge). The expansion and contraction of the piezoelectric elements causes the vibration board to produce air vibration.

Each of the supersonic transducer 23 is disposed on a support board 24 in the supersonic speaker housing 22, and serves as a speaker array.

More practically, the support board 24 is a disk shape round board, on one side of which, the plurality of supersonic transducers 23 are arranged. Specifically, the supersonic transducers 23 are arranged in a horizontally-arranged array in multiple rows in the vertical direction, thereby forming the speaker array.

The supersonic sound generated by the supersonic transducer 23 is radiated through a speaker opening 27 (i.e., a supersonic radiation hole) of the supersonic speaker 21 outwardly in a front direction of the vehicle. The speaker opening 27 is covered by a waterproof unit that prevents foreign matter as well as water from intruding into the installation position of each of the supersonic transducer.

The waterproof unit may be implemented as a waterproof sheet 25, as shown in FIG. 3, that prevents water from entering the speaker opening 27 but permits the supersonic sound to radiate from the speaker opening 27. The waterproof sheet 25 is supplemented by a louver 26 installed in front of it.

Further, the louver 26 is arranged in front of the waterproof sheet 25 to substantial reduce the amount of water that may reach the waterproof sheet 25, and prevents the water to directly hit the waterproof sheet 25. The louver 26 is provided as a long and narrow element, arranged in parallel with each other.

The louver 26 has an angle of about 45 degrees against the horizontal direction of the vehicle, as shown in FIG. 3. Due to such arrangement of the louver 26, the supersonic sound from each of the supersonic transducer 23 is reflected on one of the louver element in a downward direction, then reflected again in the horizontal direction, thereby radiating the supersonic sound toward the front direction of the vehicle.

(Control Circuit 3)

As shown in FIG. 4A, the vehicular horn 1 includes the control circuit 3 in a horn housing. The control circuit 3, implemented as a microcomputer chip 3a (FIG. 3) on a control substrate, includes (FIG. 2):

(a) a notification sound generation unit 31 for generating a sound signal, which in the current embodiment is a pseudo-idling sound signal, but may be a sound signal that is representative of another sound, such as a chime or the like

(b) a horn drive amplifier 32 for driving the vehicular horn 1 according to the pseudo-idling sound signal,

(c) a supersonic sound modulation unit 33 for modulating the pseudo-idling sound signal into a supersonic sound signal having the supersonic frequency,

(d) a first supersonic drive amplifier 34 for driving every other supersonic transducers 23 that is an odd number transducer in the horizontal array according to the supersonic sound signal, where the supersonic transducers 23 that have the odd number are designated as a supersonic transducer 23a (FIGS. 1A and 1B),

(e) a second supersonic drive amplifier 35 for driving every other supersonic transducers 23 that is an even number transducer in the horizontal array according to the supersonic sound signal, where the supersonic transducers 23 that have the even the number are designated as a supersonic transducer 23b (FIGS. 1A and 1B), and

(f) a signal process unit 36 for controlling the above-described operations.

The above-described elements of the control circuit 3 are explained in the following.

(Notification Sound Generation Unit 31)

The notification sound generation unit 31 generates a pre-stored pseudo-idling sound signal according to the information provided from the signal process unit 36.

The pseudo-idling sound signal is generated by, for example, a technique that generates a pseudo-engine sound, which generates frequency signals in many frequencies at a predetermined frequency interval in a certain frequency range.

(Horn Drive Amplifier 32)

The horn drive amplifier 32 is a power amplifier that drives the vehicular horn 1 as a dynamic speaker, by providing the pseudo-idling sound signal from the notification sound generation unit 31 to a power terminal of the vehicular horn 1 after amplification of the signal.

The horn drive amplifier 32 controls the power supplied to the coil 11 of the vehicular horn 1, so that the vehicular horn 1 does not radiate the warning sound when the vehicular horn 1 generates the pseudo-idling sound. In other words, the power is controlled so that the electric current interrupter 17 is not operated to allow and prevent the electric current in an excited manner.

(Supersonic Sound Modulation Unit 33)

The supersonic sound modulation unit 33 modulates the pseudo-idling sound signal from the notification sound generation unit 31.

The supersonic sound modulation unit 33 performs, for example, amplitude modulation (AM) for generating an amplitude change of a predetermined supersonic frequency (e.g., 25 kHz) from the pseudo-idling sound signal.

Further, the supersonic sound modulation unit 33 may use other modulation techniques, such as pulse width modulation (PWM), which modulates the pseudo-idling sound signal into a signal of width change (i.e., width of the pulse generation time) of the supersonic sound frequency (e.g., 25 kHz).

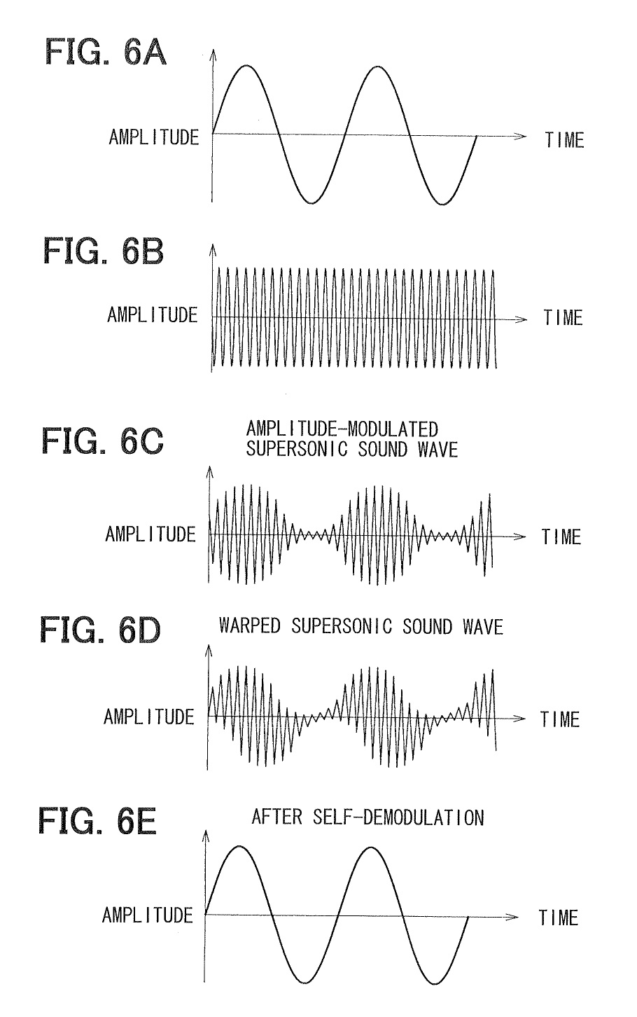

An example of the supersonic modulation by the supersonic sound modulation unit 33 is explained with reference to FIGS. 6A to 6C.

For example, the pseudo-idling sound signal is provided to the supersonic sound modulation unit 33 as a voltage change having a wave form of a single frequency in FIG. 6A. The wave form shown in FIG. 6A is provided for explanation purposes and it should be understood that the wave form may take other forms.

A supersonic sound oscillator in the control circuit 3 oscillates at a supersonic frequency shown in FIG. 6B.

In FIG. 6C, the supersonic sound modulation unit 33 performs the following:

(i) as the signal voltage of the frequency to generate a pseudo-idling sound signal increases, the supersonic sound modulation unit 33 increases the amplitude of the voltage of the supersonic sound vibration, and

(ii) as the signal voltage of the frequency to generate a pseudo-idling sound signal decreases, the supersonic sound modulation unit 33 decreases the amplitude of the voltage by the supersonic sound vibration.

In the above-described manner, the supersonic sound modulation unit 33 modulates the pseudo-idling sound signal output from the notification sound generation unit 31 into the amplitude change of the oscillation voltage having the supersonic sound frequency.

(First Supersonic Drive Amplifier 34)

The first supersonic drive amplifier 34 drives the supersonic transducers 23a, which are the odd number transducers in the horizontal array of the supersonic transducers 23, based on the supersonic sound signal that is modulated by the supersonic sound modulation unit 33. The supersonic transducers 23a generate the supersonic sound that is modulated by “the pseudo-idling sound signal,” under control of an applied voltage to the supersonic transducers 23a (i.e., by controlling the charge and discharge conditions of the transducers 23a).

(Second Supersonic Drive Amplifier 35)

The second supersonic drive amplifier 35 reverses the phase of the supersonic sound signal that is modulated by the supersonic sound modulation unit 33 by using a signal inversion circuit 35a (FIG. 2). The second supersonic drive amplifier 35 then drives the supersonic transducers 23b, which are the even number transducers in the horizontal array of the supersonic transducers 23, based on the reverse-phased supersonic sound signal. Thus, the supersonic transducers 23b generate the supersonic sound that is modulated by “the pseudo-idling sound signal,” under control of an applied voltage to the supersonic transducers 23a (i.e., by controlling the charge and discharge conditions of the transducers 23a).

(Signal Process Unit 36)

The signal process unit 36 generates the pseudo-idling sound from the vehicular horn 1 and the parametric speaker 2. The signal process unit receives an operation instruction signal from an electronic control unit (ECU) disposed in the vehicle. The operation instruction signal is indicative of a stop condition of the vehicle. Specifically, the operation instruction signal is sent by the ECU to the signal process unit 36 when the vehicle is at a temporary stop, such as at a crosswalk, a traffic signal, a stop sign, or the like. If the vehicle includes an engine with an idle-stop function, the operation instruction signal is indicative of a stop condition of the vehicle and of the engine.

(Operation of the Vehicle Presence Notification Apparatus)

When the operation instruction signal is provided to the signal process unit 36 from the ECU, the supersonic speaker 21 generates and outputs the supersonic sound, which is not audible. Specifically, once the operation instruction signal is provided to the signal process unit 36, the supersonic sound modulation unit 33 modulates the pseudo-idling sound signal that is provided by the notification sound generation unit 31, and the first supersonic drive amplifier 34 and the second supersonic drive amplifier 35 drive the supersonic transducers 23. The supersonic transducers 23 generates the supersonic sound (example FIG. 6C), and the supersonic sound radiates outward from the vehicle.

The supersonic sound wave having a short wavelength is warped by the viscosity of the air as the supersonic sound travels in the air (FIG. 6D). As a result, an amplitude component of the supersonic sound wave is self-demodulated during the travel (FIG. 6E), thereby reproducing the pseudo-idling sound at a distant position in front of the vehicle. That is, the pseudo-idling sound is reproduced as an audible sound at a position distant from the vehicle.

Further, when the ECU provides the operation instruction signal to the signal process unit 36, the signal process unit 36 controls the vehicular horn 1 as a dynamic speaker, and the vehicular horn 1 generates the pseudo-idling sound.

(Advantageous Effects—No. 1)

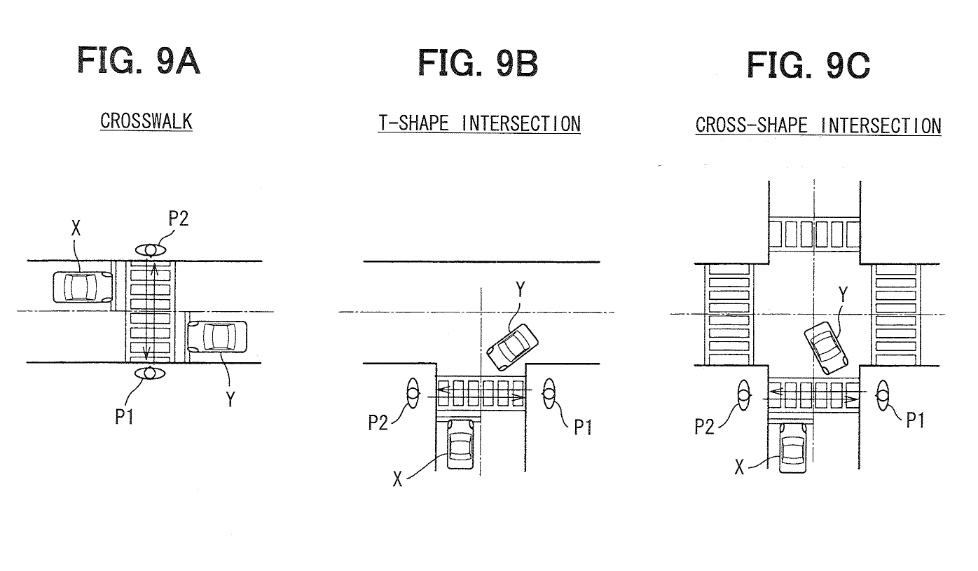

The vehicle of the present embodiment is provided as a quiet vehicle with the vehicle presence notification apparatus disposed within. Therefore, when the vehicle stops at a traffic signal or when the vehicle is stopping in front of a crosswalk (FIG. 9A), or when the vehicle is stopping at an intersection in front of the crosswalk (FIGS. 9B and 9C), the vehicle may generate an idle sound that would notify the presence of the vehicle to a pedestrian in the vicinity of the vehicle.

The vehicle presence notification apparatus generates and radiates a notification sound in the form of a pseudo-idling sound outward from the vehicle by both of the vehicular horn 1 and the parametric speaker 2.

In such manner, a pedestrian is notified of the presence of the vehicle while the vehicle is stopped at or around the intersection, the crosswalk, or the like.

(Advantageous Effects—No. 2)

In the case of a vehicle that has an engine, such as a hybrid vehicle with an idle-stop function, the vehicle presence notification apparatus of the present embodiment does not generate the pseudo-idling sound simply because the vehicle is in a stop condition. That is, the pseudo-idling sound is generated when the vehicle is in the stop condition and the engine is also stopped or turned-off due to the idle stop function.

Therefore, the vehicle presence notification apparatus of the present embodiment does not generate the “pseudo-idling sound” when the vehicle is in a stop condition and the engine of the vehicle is still on because the engine is producing the actual idling sound. As a result, useless pseudo-idling sound is not generated when the engine is not stopped, that is, while the actual idling sound is generated by the engine.

(Advantageous Effects—No. 3)

The vehicle presence notification apparatus of the present embodiment generates the “pseudo-idling sound” by using the parametric speaker 2, and the parametric speaker 2 radiates the supersonic sound outward from the vehicle to reproduce the audible sound (i.e., the pseudo-idling sound) at a distant location from the vehicle. Further, the supersonic sound is easily reflected by nature, thereby, the pseudo-idling sound produced by the parametric speaker 2 does not transmit toward the driver and/or occupants of the vehicle. Therefore, the sound quality of the passenger compartment of the vehicle is not effected, and prevents discomfort to the occupants of the vehicle.

(Advantageous Effects—No. 4)

With reference to FIG. 1B, when the supersonic transducers 23 horizontally positioned next to each other (i.e. supersonic transducer 23a and supersonic transducer 23b) generate the same-phase supersonic sound, the two adjacent supersonic sounds transmitting in a front direction amplify each other due to the same wave phase, thereby having an increased coverage area/distance in the front direction.

However, such arrangement of the supersonic transducers 23 weakens the supersonic sound transmitting in a diagonally-right/left directions because the supersonic sound from two adjacent supersonic transducers 23 are in reverse phase and cancel each other. Therefore, the coverage area/distance of the supersonic sound in the diagonally-right/left directions is decreased.

With reference to FIG. 1A, the coverage area of the pseudo-idling sound from two adjacent supersonic transducers 23 that generate the same phase sound are illustrated by broken line β. The coverage area surrounded by the broken line β and the line a indicates a sound pressure measurement of at least 50 dB.

With reference to FIG. 1C, the vehicle presence notification apparatus of the present embodiment is arranged to have two adjacent supersonic transducers 23 next to each other in a horizontal direction (i.e. supersonic transducer 23a and supersonic transducer 23b) generate the supersonic sound of reverse phase in the front direction, when the supersonic sound from the apparatus is used to generate the pseudo-idling sound while the vehicle is in the stop condition.

In such manner, the supersonic sounds transmitting in the diagonally-right/left directions have the same phase, thereby preventing cancellation of the supersonic sound, and, instead, amplify each other. As a result, the coverage area/distance of the supersonic sound in those diagonal directions is increased.

In FIG. 1A, the coverage areas of the pseudo-idling sound from the two adjacent transducers 23 generating the reverse phase sound are illustrated by using a solid line β′. The coverage areas surrounded by the solid line β′ indicates the sound pressure measurement of at least 50 dB.

As shown by the solid line β′ in FIG. 1A, the extended coverage of the pseudo-idling sound in the diagonally-right/left directions from the vehicle presence notification apparatus of the present embodiment may cover the position of the walker standing on both sides of the crosswalk, when the vehicle temporarily stops in front of the crosswalk. Therefore, the existence of the vehicle while the vehicle is temporarily stopped in front of the crosswalk is more securely notified for the walker by the apparatus through the pseudo-idling sound. Additionally the coverage area of the pseudo-idling sound from the dynamic speaker (the vehicular horn 1) is illustrated by line a. The coverage area surrounded by the line a indicates a sound pressure measurement of at least 50 dB.

### Second Embodiment

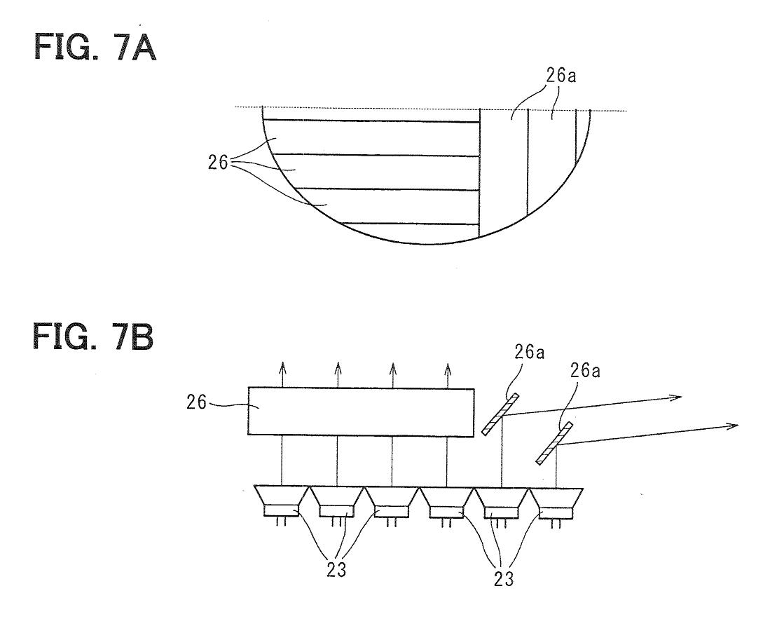

The second embodiment of the present disclosure is described with reference to FIGS. 7A and 7B. Like parts in the second embodiment as the first embodiment have like numbers.

In the first embodiment, the reverse-phased supersonic sounds are generated by the two horizontally-adjacent supersonic transducers 23, in order to have the extended coverage of the supersonic sound in the diagonally-right/left directions.

In contrast, the shape of the louver 26 is changed, as shown in FIG. 7A, to have a right-biasing louver 26a on a right side of the louver 26 in the second embodiment. In such manner, supersonic sounds from the right-side supersonic transducers 23 (i.e., the supersonic transducers 23 disposed on the vehicle's right side) are reflected rightward in a positive manner, or in a concentrated manner, thereby achieving the extended coverage of the pseudo-idling sound that reaches the walker standing a far-right side of the vehicle at an end of the crosswalk. As a result, the walker's safety is improved by such sound from the vehicle presence notification apparatus.

### Third Embodiment

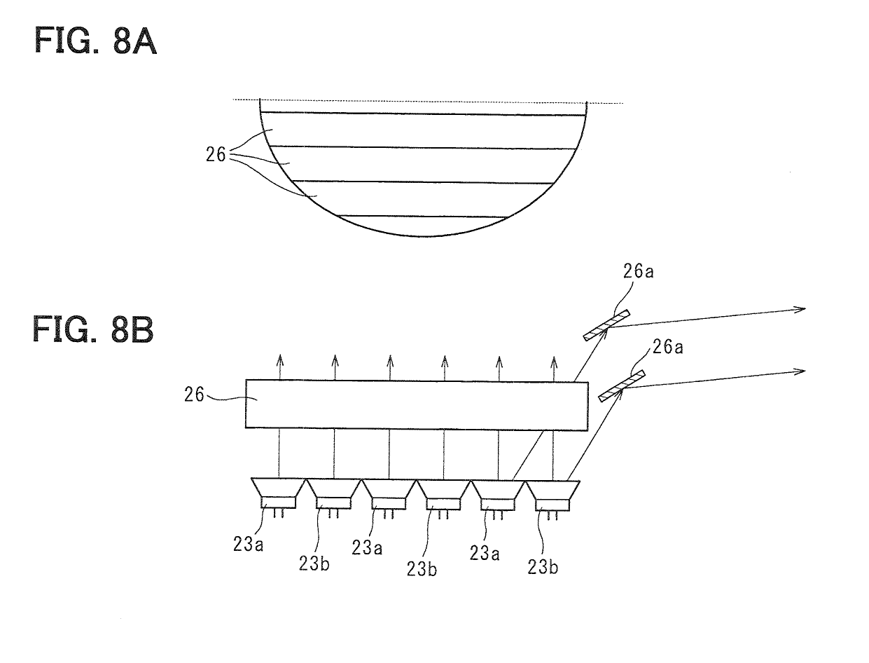

The third embodiment of the present disclosure is described with reference to FIGS. 8A and 8B. The third embodiment is a combination of the first and the second embodiments. The supersonic speaker 21 shown in the first embodiment is combined with the right-biasing louver 26a in the second embodiment, to reflect a rightward-transmitting supersonic sound into a further-rightward direction of the vehicle as shown in FIG. 8B.

By combining the first embodiment and the second embodiment in such manner, (i) the advantages in the first embodiment, which extends the coverage of the pseudo-idling sound in the diagonally-right/left directions to convey the sound to a distant position from the vehicle, based on the generation of the reverse phase supersonic sound from the horizontally-adjacent two supersonic transducers 23, and (ii) the advantages in the second embodiment, which extends the coverage of the pseudo-idling sound by further reflecting the supersonic sound in a positive manner by using the right-biasing louver 26a to convey the sound to the walker on a far-right side of the vehicle, are combined to further extend the coverage of the supersonic sound toward the right side of the vehicle.

Therefore, the pseudo-idling sound is transmitted from the vehicle presence notification apparatus to the walker standing on a far-right side of the vehicle at an end of the crosswalk, when the vehicle is temporarily stopping in front of the crosswalk (e.g., FIG. 9A), thereby notifying the existence of the vehicle and improving the walker's safety and traffic safety.

In the embodiments mentioned above, the vehicle presence notification apparatus is applicable to quiet vehicles, such as engineless vehicles (electric/fuel cell), hybrid vehicles with an idle-stop function, and conventional vehicles with idle stop function. Further, even when the engine vehicle is not equipped with the idle stop function, the present disclosure may also be suitably applicable to such vehicles when the idling sound of the vehicle is quiet.

Further, from the hybrid vehicle and the engine-less vehicle which travels by using the electric motor, the actual engine sound is not generated even when the vehicle is traveling. Therefore, the notification sound such as a pseudo-engine sound, a pseudo-travel sound, a chord, or a single sound may be generated by the vehicle presence notification apparatus, during the travel of the vehicle, such as at a travel speed of 20 km/h or lower, for notifying the existence of the vehicle to the surrounding area.

As described above, when the vehicle presence notification apparatus is operated during a travel of the vehicle, the horizontally-adjacent supersonic transducers 23 next to each other may be configured to generate the same-phase supersonic sounds (FIG. 1B), and when the vehicle presence notification apparatus is operated during a temporary stop state (i.e. stop condition) of the vehicle, the horizontally-adjacent supersonic transducers 23 next to each other may be configured to generate the reverse-phase supersonic sounds (FIG. 1C). Such a switching of the wave phase of the supersonic sound may be preferably.

In the embodiments mentioned above, the generation of the pseudo idling sound can be based on the temporary stop state of the vehicle and, additionally, based on the fulfillment of a predetermined driving condition. For example, when the vehicle has an engine with an idle-stop function the predetermined driving condition can be provided as when the engine is stopped as a result of the idle stop function. Accordingly, the pseudo idling sound is generated when the vehicle is in temporary stop state and when the predetermined driving condition is fulfilled (i.e. when the engine is stopped as result of the idle stop function).

The predetermined driving condition may be different from the engine stopping due to an idle stop function. For example, the predetermined driving condition may also be when the vehicle is set in a D range gear position (i.e., a forward travel gear position), a drive (D) or a reverse (R) range gear position (i.e., forward/reverse travel gear positions), a no-leading vehicle state of having no leading vehicle, a navigated state in front of an intersection or a crosswalk based on information from a navigation apparatus, an intersection instruction receiving state of receiving information/instruction from an approaching intersection, or a visually-impaired instruction receiving state of receiving information/instruction from the visually-impaired. Such predetermine driving conditions may also be combined with the temporary stop state of the vehicle to serve as a condition for generating the pseudo-idling sound.

In the embodiment mentioned above, the example shows that the pseudo-idling sound is generated from both of the parametric speaker 2 and the dynamic speaker (i.e., the vehicular horn 1). However, the pseudo-idling sound may be generated by only one of the parametric speaker 2 or the dynamic speaker.

In the embodiment mentioned above, the example shows that the pseudo-idling sound is generated as the notification sound for notifying the existence of the vehicle that is in a temporary stop state. However, any sound may be generated and radiated from the vehicle presence notification apparatus, as long as such sound is capable of notifying the existence of the vehicle that is the temporary stop state.

Based on the above, the vehicle presence notification apparatus includes a sound generation unit that radiates a sound outward from the vehicle, and a control circuit 3 that generates a pseudo-idling sound (i.e., an example of a notification sound) for notifying the existence of the vehicle that is a temporary stop state, by controlling the sound generation unit.

In the present embodiment, the sound wave generation unit is provided as the vehicular horn 1, which is operated as a dynamic speaker, and a parametric speaker 2. Although such form of the present disclosure does not limit a scope of the disclosure.

The control circuit 3 of the present embodiment generates a pseudo-idling sound from the sound wave generation unit when the vehicle is in a temporary stop state and a certain driving condition is fulfilled.

More practically, when the vehicle includes an engine that has an idle stop function, the control circuit 3 generates a pseudo-idling sound from the sound wave generation unit when the vehicle is in a temporary stop state and when the engine is stopped or turned off by the idle stop function, which is provided as the certain driving condition.

What is claimed is:

1. A vehicle presence notification apparatus comprising:
a sound wave generation unit for radiating a sound wave outward from a vehicle; and
a control circuit for controlling the sound wave generation unit to generate a notification sound that notifies existence of the vehicle when the vehicle is in a temporary stop state.

2. The vehicle presence notification apparatus of claim 1, wherein
the control circuit controls the sound wave generation unit to generate the notification sound when the vehicle is in a temporary stop state and a predetermined driving condition is fulfilled.

3. The vehicle presence notification apparatus of claim 2, wherein
the vehicle has an engine with an idle stop function, and
the predetermined driving condition is that the engine is in a stop state, which is caused by the idle stop function.

4. The vehicle presence notification apparatus of claim 1, wherein
the sound wave generation unit is a parametric speaker that radiates a supersonic sound outward from the vehicle based on a supersonic modulation of the notification sound.

5. The vehicle presence notification apparatus of claim 4, wherein
the parametric speaker includes a supersonic speaker that radiates the supersonic sound outward from the vehicle,
the supersonic speaker has a plurality of supersonic transducers positioned in a horizontal array in a collective arrangement for emitting the supersonic sound, and
the control circuit further controls horizontally-adjacent supersonic transducers to generate reverse-phased supersonic sounds for generating the notification sound when the vehicle is in a temporary stop state.

6. The vehicle presence notification apparatus of claim 4, wherein
the parametric speaker includes a supersonic speaker that radiates the supersonic sound outward from the vehicle,
the supersonic speaker has a plurality of supersonic transducers for emitting the supersonic sound, and
the supersonic speaker has a rightward-biasing louver for reflecting, toward a right side of the vehicle, the supersonic sound emitted by a portion of the supersonic transducers.
